(19) United States
(12) Patent Application Publication
(10) Pub. No.: US 2019/0130053 A1
(43) Pub. Date: May 2, 2019

(54) METHOD AND APPARATUS FOR ADJUSTING PRODUCT MODEL, AND STORAGE MEDIUM

(71) Applicant: Siemens Aktiengesellschaft, Munich (DE)

(72) Inventor: Dian Song CAO, Beijing (CN)

(73) Assignee: Siemens Aktiengesellschaft, Munich (DE)

(21) Appl. No.: 16/034,425

(22) Filed: Jul. 13, 2018

(30) Foreign Application Priority Data
Sep. 30, 2017 (CN) 201710923348.1

(51) Int. Cl. G06F 17/50

(52) U.S. Cl. CPC G06F 17/50; G06F 2217/04

(57) ABSTRACT

Disclosed in embodiments are a method and apparatus for adjusting a product model, and a storage medium. The method for adjusting a product model includes determining a life cycle data type of a product corresponding to the product model; collecting, in a life cycle of the product, a parameter value which is associated with the product and complies with the life cycle data type; and adjusting the product model based upon the parameter value collected. In an embodiment, the product model is adjusted based upon a parameter of a product life cycle type, so that the product model can reflect the real state of the product throughout the life cycle, thereby improving the accuracy of the product model.

### PRIORITY STATEMENT

The present application hereby claims priority under 35 U.S.C. § 119 to Chinese patent application number CN 201710923348.1 filed Sep. 30, 2017, the entire contents of which are hereby incorporated herein by reference.

### FIELD

At least one embodiment of the present invention generally relates to the technical field of product modeling, in particular to a method and apparatus for adjusting a product model, and a storage medium.

### BACKGROUND

System modeling refers to the necessary simplification of an entity being studied, and the use of a suitable form of realization or rule to describe the main features of the entity. A system imitation obtained by system modeling is called a model. At present, many tasks relating to product design, development, testing and services can be realized on the basis of physical prototypes and models. A digital model of a product (abbreviated as product model) is the basis for completing these tasks.

### SUMMARY

The inventor discovered that a product model is generally created in a design stage, and is unable to reflect the real state of the product corresponding to the product model throughout the life cycle.

Embodiments of the present invention propose a method and apparatus for adjusting a product model, and a storage medium.

At least one embodiment of the present invention is directed to a method for adjusting a product model, comprising:
determining a life cycle data type of a product corresponding to the product model;
collecting, in a life cycle of the product, a parameter value which is associated with the product and complies with the life cycle data type; and
adjusting the product model on the basis of the parameter value collected.

At least one embodiment is directed to apparatus for adjusting a product model comprises:
a data type determining module, for determining a life cycle data type of a product corresponding to the product model;
a parameter value collecting module, for collecting, in a life cycle of the product, a parameter value which is associated with the product and complies with the life cycle data type;
a product model adjusting module, for adjusting the product model on the basis of the parameter value collected.

An embodiment is directed to a storage medium, having a machine-readable instruction stored therein, the machine-readable instruction being used for executing any one of embodiments of the methods.

### BRIEF DESCRIPTION OF THE DRAWINGS

FIG. 1 is a flow chart of the method for adjusting a product model according to an embodiment of the present invention.

FIG. 2 is a schematic diagram of a processing procedure for adjusting a product model on the basis of life cycle data collected in a production process according to an embodiment of the present invention.

FIG. 3 is a demonstrative flow chart of the processing procedure shown in FIG. 2.

FIG. 4 is a schematic diagram of a processing procedure for adjusting a product model on the basis of life cycle data collected in a use process according to an embodiment of the present invention.

FIG. 5 is a demonstrative flow chart of the processing procedure shown in FIG. 4.

FIG. 6 is a schematic diagram of a processing procedure for adjusting a product model on the basis of life cycle data collected in a production process and a use process according to an embodiment of the present invention.

FIG. 7 is a demonstrative flow chart of the processing procedure shown in FIG. 6.

FIG. 8 is a structural diagram of an apparatus for adjusting a product model according to an embodiment of the present invention.

Key to the drawings:

| Label | Meaning |
|---|---|
| 101-103 | steps |
| 10 | product design process |
| 20 | product production process |
| 30 | product use process |
| 40 | life cycle timeline |
| 21 | product model |
| 22 | simulation tool |
| 23 | data definer |
| 24 | data collector |
| 25 | first collecting side |
| 26 | second collecting side |
| 801 | data type determining module |
| 802 | parameter value collecting |
| | module |
| 803 | product model adjusting |
| | module |
| 803 | identifier generating module |

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated. The present invention, however, may be embodied in many alternate forms and should not be construed as limited to only the example embodiments set forth herein.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Before discussing example embodiments in more detail, it is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments of the present invention. This invention may, however, be embodied in many alternate forms and should not be construed as limited to only the embodiments set forth herein.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one embodiment of the invention relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

At least one embodiment of the present invention is directed to a method for adjusting a product model, comprising:
determining a life cycle data type of a product corresponding to the product model;
collecting, in a life cycle of the product, a parameter value which is associated with the product and complies with the life cycle data type; and
adjusting the product model on the basis of the parameter value collected.

In an embodiment of the present invention, the product model is adjusted on the basis of a parameter of a product life cycle type, so that the product model can reflect the real state of the product throughout the life cycle, thereby improving the accuracy of the product model.

In one embodiment, the life cycle data type comprises one or more design parameters of the product;
the collecting, in a life cycle of the product, a parameter value which is associated with the product and complies with the life cycle data type, comprises: acquiring, in a production process of the product, a parameter value of the one or more design parameters from a product data management system or a manufacturing execution system.

The product life cycle in an embodiment of the present invention comprises the production process, and the parameter value of the design parameter can be acquired by means of the product data management system or manufacturing execution system, hence the product model can be adaptively improved on the basis of a real value in the production process.

In one embodiment, the life cycle data type comprises one or more performance indices of the product;
the collecting, in a life cycle of the product, a parameter value which is associated with the product and complies with the life cycle data type, comprises: acquiring, in a use process of the product, an index value of the one or more performance indices from a manufacturing execution system or an industrial Internet of Things.

The product life cycle in an embodiment of the present invention comprises the use process, and the parameter value of the design parameter can be acquired by means of the manufacturing execution system or industrial Internet of Things, hence the product model can be adaptively improved on the basis of a real value in the use process.

In one embodiment, the life cycle data type comprises one or more design parameters of the product and one or more performance indices of the product;
the collecting, in a life cycle of the product, a parameter value which is associated with the product and complies with the life cycle data type, comprises: acquiring, in a production process of the product, a parameter value of the one or more design parameters from a product data management system or a manufacturing execution system, and acquiring, in a use process of the product, an index value of the one or more performance indices from a manufacturing execution system or an industrial Internet of Things.

Hence, in an embodiment of the present invention, real values in the production process and the use process can be used to adaptively improve the data model.

In one embodiment, the method also comprises:
generating a unique identifier of the life cycle data type;
the collecting a parameter value which is associated with the product and complies with the life cycle data type comprises:
sending the unique identifier of the life cycle data type and a data source of the life cycle data type to a collecting side;
receiving, from the collecting side, a parameter value which originates in the data source, is identified using the unique identifier, is associated with the product and complies with the life cycle data type.

In an embodiment of the present invention, the generation of the unique identifier for the life cycle data type facilitates the locating, tracking and acquisition of life cycle data throughout the life cycle.

In one embodiment, the collecting side comprises at least one of the following:
a product data management system; a manufacturing execution system; an industrial Internet of Things.

In one embodiment, the adjusting of the product model on the basis of the parameter value collected comprises:
inputting the parameter value collected into the product model, enabling the product model to adjust a performance index or design parameter included in the product model on the basis of a result of comparing a statistical analysis result of the parameter value with a predetermined threshold; or
inputting the parameter value collected into a simulation tool, and adjusting a performance index or design parameter included in the product model on the basis of an output result of the simulation tool.

In embodiments of the present invention, it is possible to adjust the product model in more than one way using real values acquired in the life cycle, thereby increasing the accuracy of the product model.

At least one embodiment is directed to apparatus for adjusting a product model comprises:
a data type determining module, for determining a life cycle data type of a product corresponding to the product model;
a parameter value collecting module, for collecting, in a life cycle of the product, a parameter value which is associated with the product and complies with the life cycle data type;
a product model adjusting module, for adjusting the product model on the basis of the parameter value collected.

In an embodiment of the present invention, the product model is adjusted on the basis of a parameter of a product life cycle type, so that the product model can reflect the real state of the product throughout the life cycle, thereby improving the accuracy of the product model.

In one embodiment, the life cycle data type comprises one or more design parameters of the product;
the parameter value collecting module is used for acquiring, in a production process of the product, a parameter value of the one or more design parameters from a product data management system or a manufacturing execution system.

The product life cycle in an embodiment of the present invention comprises the production process, and the parameter value of the design parameter can be acquired by means of the product data management system or manufacturing execution system, hence the product model can be adaptively improved on the basis of a real value in the production process.

In one embodiment, the life cycle data type comprises one or more performance indices of the product;
the parameter value collecting module is used for acquiring, in a use process of the product, an index value of the one or more performance indices from a manufacturing execution system or an industrial Internet of Things.

The product life cycle in an embodiment of the present invention comprises the use process, and the parameter value of the design parameter can be acquired by way of the manufacturing execution system or industrial Internet of Things, hence the product model can be adaptively improved on the basis of a real value in the use process.

In one embodiment, the life cycle data type comprises one or more design parameters of the product and one or more performance indices of the product;
the parameter value collecting module is used for acquiring, in a production process of the product, a parameter value of the one or more design parameters from a product data management system or a manufacturing execution system, and for acquiring, in a use process of the product, an index value of the one or more performance indices from a manufacturing execution system or an industrial Internet of Things.

Hence, in an embodiment of the present invention, real values in the production process and the use process can be used to adaptively improve the data model.

In one embodiment, also included is:
an identifier generating module, for generating a unique identifier of the life cycle data type,
wherein the parameter value collecting module is used for sending the unique identifier of the life cycle data type and a data source of the life cycle data type to a collecting side, and receiving, from the collecting side, a parameter value which originates in the data source, is identified using the unique identifier, is associated with the product and complies with the life cycle data type.

In an embodiment of the present invention, the generation of the unique identifier for the life cycle data type facilitates the locating, tracking and acquisition of life cycle data throughout the life cycle.

In one embodiment, the collecting side comprises at least one of the following:
a product data management system; a manufacturing execution system; an industrial Internet of Things.

In one embodiment, the product model adjusting module is used for inputting the parameter value collected into the product model, enabling the product model to adjust a performance index or design parameter included in the product model on the basis of a result of comparing a statistical analysis result of the parameter value with a predetermined threshold; or is used for inputting the parameter value collected into a simulation tool, and adjusting a performance index or design parameter included in the product model on the basis of an output result of the simulation tool.

Hence, in embodiments of the present invention, it is possible to adjust the product model in more than one way using real values acquired in the life cycle, thereby increasing the accuracy of the product model.

An embodiment is directed to a storage medium, having a machine-readable instruction stored therein, the machine-readable instruction being used for executing any one of embodiments of the methods.

The present invention is explained in further detail below in conjunction with the accompanying drawings and embodiments, to clarify the technical solution and advantages thereof. It should be understood that the particular embodiments described here are merely intended to explain the present invention elaboratively, not to define the scope of protection thereof.

The solution of the present invention is expounded below by describing a number of representative embodiments, in order to make the description concise and intuitive. The large number of details in the embodiments are merely intended to assist with understanding of the solution of the present invention. However, obviously, the technical solution of the present invention need not be limited to these details when implemented. To avoid making the solution of the present invention confused unnecessarily, some embodiments are not described meticulously, but merely outlined. Hereinbelow, “comprises” means “including but not limited to”, while “according to . . . ” means “at least according to . . . , but not limited to only according to . . . ”. In line with the linguistic customs of Chinese, in cases where the quantity of a component is not specified hereinbelow, this means that there may be one or more of the component; this may also be interpreted as meaning at least one.

In an embodiment of the present invention, a method is proposed for using product life cycle data acquired in a product life cycle to adjust a product model.

The product model is a digital model of a product. The product may be a physical product having a specific physical shape, e.g. a production component in an industrial field, and the corresponding product model is a 3D design model of the component. The product could also be a software module without a specific shape, e.g. control software in an automatic control field, in which case the corresponding product model is a control model.

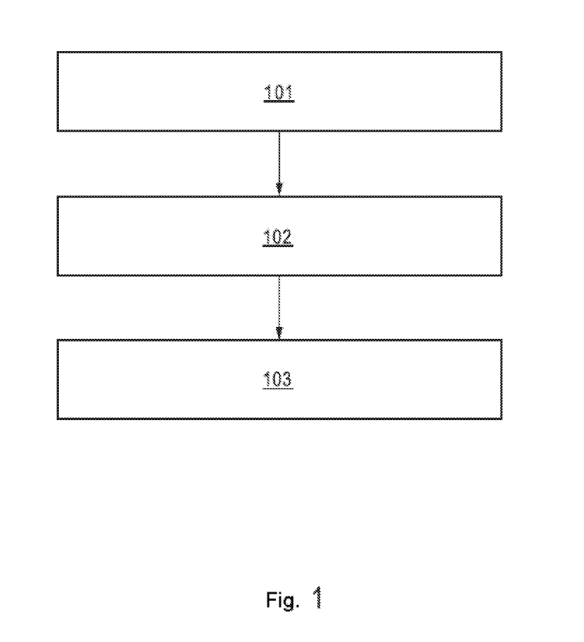

FIG. 1 is a flow chart of the method for adjusting a product model according to an embodiment of the present invention.

As FIG. 1 shows, the method comprises:

Step 101: determining a life cycle data type of the product corresponding to the product model.

Here, the life cycle of the product may comprise a product design process, a product production process and a product use process. In the product design process, a developer develops the product model (e.g. a 3D digital model of the product) on the basis of a predetermined requirement. In the product production process, a manufacturer produces the product on the basis of the product model developed in the product design process. In the product use process, a user uses the product produced in the product production process.

The life cycle data type refers to a data type which is generated in the life cycle of the product and is associated with a specific design parameter or performance index of the product. For example, the life cycle data type of the product may comprise a design parameter of the product or a performance index of the product, wherein the number of design parameters may be one or more, and the number of performance indices may also be one or more. The design parameter may be shown directly in a product model number, e.g. the length of a physical component, etc. Performance specifications specify product performance and operating conditions, and cannot be covered by design parameters, e.g. locating precision of a moving component or average working time of a fault, etc.

In general, it is possible to acquire a specific parameter value of a design parameter in the product production process, and to acquire a specific index value of a performance index in the product use process.

For instance, supposing that the product is a valve bolt hole, the life cycle data type may comprise valve bolt hole processing precision as a design parameter and valve bolt hole life as a performance index.

Step 102: collecting, in the life cycle of the product, a parameter value which is associated with the product and complies with the life cycle data type.

Here, when the life cycle data type comprises one or more design parameters of the product, a parameter value of one or more design parameters may be acquired from a product data management (PDM) system or a manufacturing execution system (MES) in the production process of the product.

PDM systems are widely used in various industrial fields at present. The PDM system can manage product structure and configuration, component definitions and design data, CAD drawing files, engineering analysis and verification data, manufacturing projects and specifications, NC programming files, image files (e.g. photographs, modeling images, scanned images), product manuals, software products (programs, inventories, functions), various electronic reports, cost accounting, product notes, etc., project planning books, multimedia audiovisual products, hard copy files, other electronic data, etc. Preferably, in the production process of the product, a parameter value of one or more design parameters may be actively requested from the PDM system, or a parameter value of one or more design parameters actively provided by the PDM system may be received.

An MES system is a product informatization management system facing a workshop execution layer of a manufacturing firm. The MES can provide management modules for the firm including manufacturing data management, project schedule management, production schedule management, inventory management, quality management, human resource management, working centre/equipment management, tool/tooling management, purchase management, cost management, project dashboard management, production process control, underlying data integration analysis and upper-layer data integration decomposition. Preferably, in the production process of the product, a request to acquire a parameter value of one or more design parameters may be actively made to the MES system, or a parameter value of one or more design parameters actively provided by the PDM system may be received.

In one embodiment, when the life cycle data type comprises one or more performance indices of the product, an index value of one or more performance indices may be acquired from an MES system or an industrial Internet of Things in the use process of the product.

The industrial Internet of Things continuously integrates various collecting or controlling sensors or controllers having perception and monitoring ability into every step of an industrial production process, thereby vastly increasing manufacturing efficiency, improving product quality, reducing product costs and resource consumption, and finally raising traditional industry to a new, intelligent stage. Preferably, in the use process of the product, a request to acquire a parameter value of one or more design parameters may be actively made to the MES system or industrial Internet of Things, or a parameter value of one or more design parameters actively provided by the MES system or industrial Internet of Things may be received.

Step 103: adjusting the product model on the basis of the parameter value collected.

In one embodiment, the parameter value collected is inputted into the product model, enabling the product model to adjust a performance index or design parameter included in the product model on the basis of a result of comparing a statistical analysis result of the parameter value with a predetermined threshold.

In another embodiment, the parameter value collected is inputted into a simulation tool, and a performance index or design parameter included in the product model is adjusted on the basis of an output result of the simulation tool.

In another embodiment, the method may further comprise: generating a unique identifier of the life cycle data type. At this time, the operation of collecting a parameter value which is associated with the product and complies with the life cycle data type in step 102 comprises: sending the unique identifier of the life cycle data type and a data source of the life cycle data type to a collecting side; and receiving, from the collecting side, a parameter value which originates in the data source, is identified using the unique identifier, is associated with the product and complies with the life cycle data type. Preferably, the collecting side comprises a PDM system, an MES system, an industrial Internet of Things or another third-party database, etc.

An embodiment of the present invention also defines a unique identifier for each life cycle data type. For example, the unique identifier comprises a combination of an organization name, a model name and a parameter index name. For example, net.siemens.motor.model1234.para1234. Since the life cycle data and the unique identifier thereof are defined in a product design stage, the unique identifier can facilitate the collecting of corresponding life cycle data during product manufacture and use.

Demonstrative embodiments of embodiments of the present invention are described below in conjunction with particular examples.

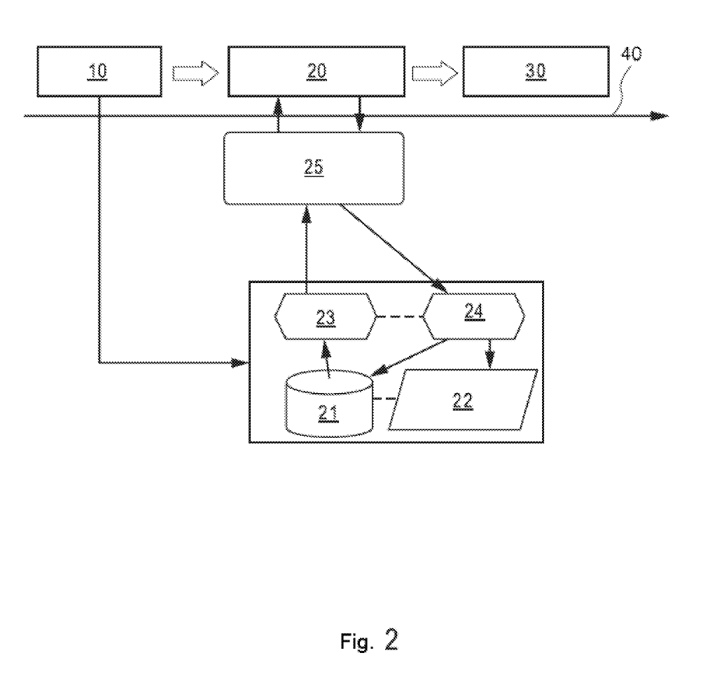

FIG. 2 is a schematic diagram of a processing procedure for adjusting a product model on the basis of life cycle data collected in a production process according to an embodiment of the present invention.

As shown in FIG. 2, according to the direction indicated by the arrow of a life cycle timeline 40, the life cycle of a product successively goes through a product design process 10, a product production process 20 and a product use process 30.

An output result of the product design process 10 is a product model 21; a design parameter of the product and a unique identifier thereof are defined in the product model 21 by means of a data definer 23. The data definer 23 sends the unique identifier of the design parameter and a data source corresponding to the unique identifier to a first collecting side 25. In the product production process 20, the first collecting side 25 acquires a parameter value of the design parameter from the data source, packages the parameter value with the unique identifier, and sends same to a data collector 24 as collected data. The data collector 24 can send the collected data to the data model 21 directly, so that the product model 21 adjusts the design parameter included in the product model 21 on the basis of a result of comparing a statistical analysis result of the parameter value in the collected data with a predetermined threshold. The data collector 24 may also send the collected data to a simulation tool 22; the simulation tool 22 provides an output result to the product model 21 on the basis of the collected data, then the product model 21 adjusts the design parameter included in the product model 21 on the basis of the output result of the simulation tool 22. Preferably, the first collecting side 25 is implemented as a PDM system or MES system.

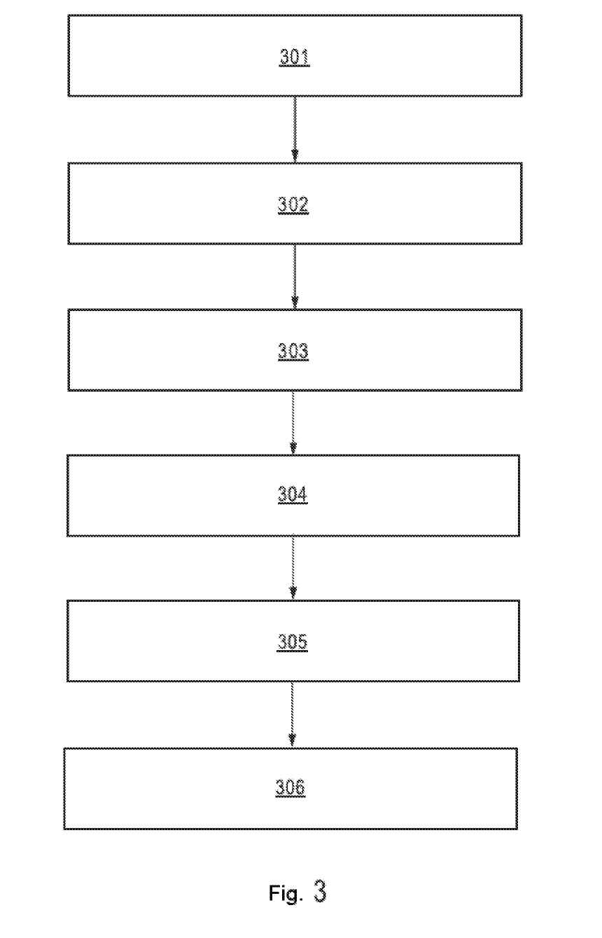

FIG. 3 is a demonstrative flow chart of the processing procedure shown in FIG. 2.

As FIG. 3 shows, the method comprises:

Step 301: the design parameter of the product and the unique identifier thereof are defined in the product model 21 by means of the data definer 23.

Step 302: the data definer 23 sends the unique identifier of the design parameter and the data source corresponding to the unique identifier to the first collecting side 25.

Step 303: in the product production process 20, the first collecting side 25 acquires the parameter value of the design parameter from the data source.

Step 304: the first collecting side 25 packages the parameter value with the unique identifier, and sends same to the data collector 24 as collected data.

Step 305: the data collector 24 can send the collected data to the data model 21 directly or to the simulation tool 22.

Step 306: the product model 21 adjusts the design parameter included in the product model 21 on the basis of the result of comparing the statistical analysis result of the parameter value in the collected data with the predetermined threshold, or the product model 21 adjusts the design parameter included in the product model 21 on the basis of the output result of the simulation tool 22.

A complete example is described below on the basis of the abovementioned procedure.

For instance, supposing that the product model 21 is a bolt hole, the defined design parameter is the hole processing precision. The data definer 23 sends a unique identifier of the hole processing precision and a data source corresponding to the unique identifier to the first collecting side 25. In the product production process 20, the first collecting side 25 acquires specific values of the processing precision of the hole that is produced, packages these specific values with the unique identifier, and sends same to the data collector 24 as collected data. At this time, the data collector 24 can send the collected data to the data model 21 directly. The product model 21 performs statistical analysis of the specific values, and if it is discovered that the number of holes unable to attain the processing precision exceeds a predetermined threshold, then a design value for the hole processing precision in the product model 21 is downgraded, or a hole manufacturing process in the product model 21 is changed, or a hole processing factory in the product model 21 is changed, etc.

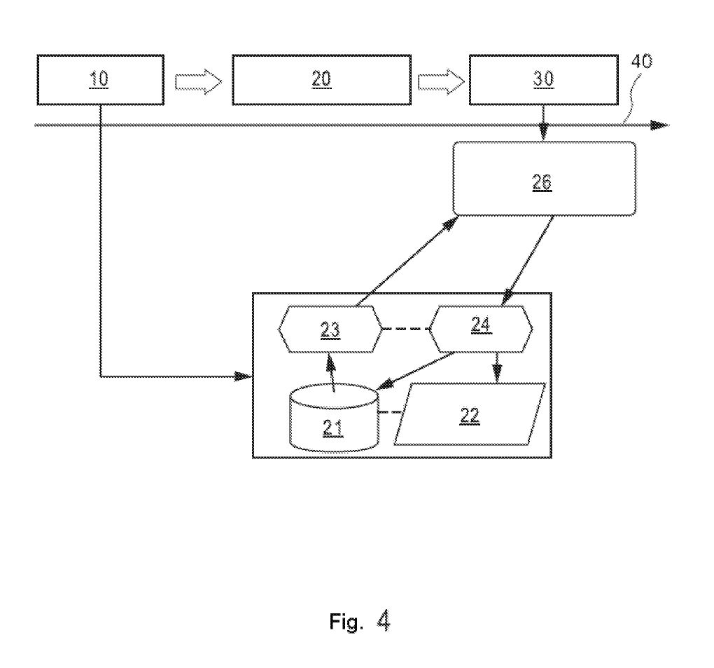

FIG. 4 is a schematic diagram of a processing procedure for adjusting a product model on the basis of life cycle data collected in a use process according to an embodiment of the present invention.

As shown in FIG. 4, according to the direction indicated by the arrow of a life cycle timeline 40, the life cycle of a product successively goes through a product design process 10, a product production process 20 and a product use process 30.

An output result of the product design process 10 is a product model 21; a performance index of the product and a unique identifier thereof are defined in the product model 21 by means of a data definer 23. The data definer 23 sends the unique identifier of the performance index and a data source corresponding to the unique identifier to a second collecting side 26. In the product use process 30, the second collecting side 26 acquires an index value of the performance index from the data source, packages the index value with the unique identifier, and sends same to a data collector 24 as collected data. The data collector 24 can send the collected data to the data model 21 directly, so that the product model 21 adjusts the performance index included in the product model 21 on the basis of a result of comparing a statistical analysis result of the index value in the collected data with a predetermined threshold. The data collector 24 may also send the collected data to a simulation tool 22; the simulation tool 22 provides an output result to the product model 21 on the basis of the collected data, then the product model 21 adjusts the performance index included in the product model 21 on the basis of the output result of the simulation tool 22. Preferably, the second collecting side 26 is implemented as an MES system or an industrial Internet of Things.

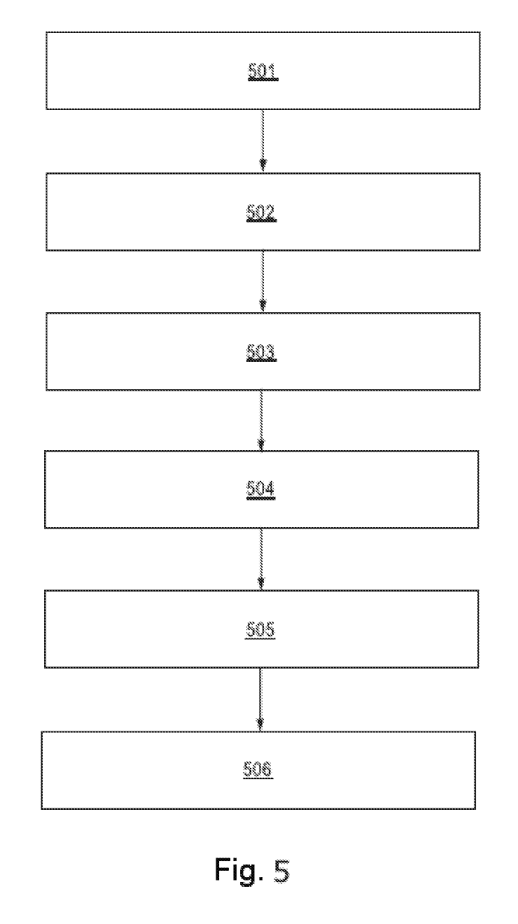

FIG. 5 is a demonstrative flow chart of the processing procedure shown in FIG. 4.

As FIG. 5 shows, the method comprises:

Step 501: the performance index of the product and the unique identifier thereof are defined in the product model 21 by means of the data definer 23.

Step 502: the data definer 23 sends the unique identifier of the performance index and the data source corresponding to the unique identifier to the second collecting side 26.

Step 503: in the product use process 20, the second collecting side 26 acquires the index value of the performance index from the data source.

Step 504: the second collecting side 26 packages the index value with the unique identifier, and sends same to the data collector 24 as collected data.

Step 505: the data collector 24 can send the collected data to the data model 21 directly or to the simulation tool 22.

Step 506: the product model 21 adjusts the index value included in the product model 21 on the basis of the result of comparing the statistical analysis result of the index value in the collected data with the predetermined threshold, or the product model 21 adjusts the index value included in the product model 21 on the basis of the output result of the simulation tool 22.

A complete example is described below on the basis of the abovementioned procedure.

For instance, supposing the product model 21 is a bolt hole, the defined performance index is hole life. The data definer 23 sends a unique identifier of the hole life and a data source corresponding to the unique identifier to the first collecting side 25. In the product use process 30, the second collecting side 26 acquires specific values of the life of the hole that is produced, packages these specific values with the unique identifier, and sends same to the data collector 24 as collected data. At this time, the data collector 24 can send the collected data to the data model 21 directly. The product model 21 performs statistical analysis of the specific values, and if it is discovered that the number of holes unable to attain the life index exceeds a predetermined threshold, then a design value for the life index in the product model 21 is downgraded, or a hole manufacturing process in the product model 21 is changed, or a hole processing factory in the product model 21 is changed.

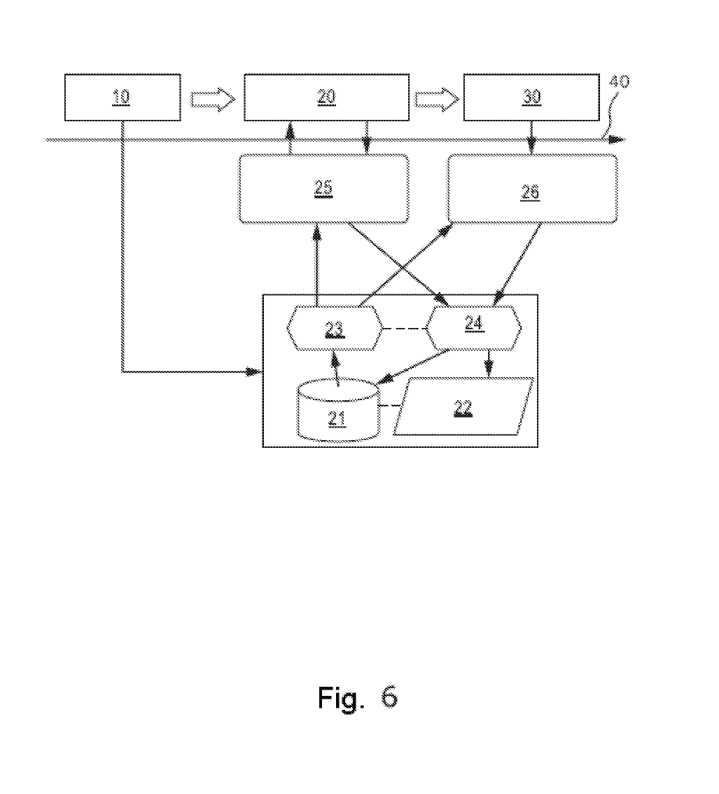

FIG. 6 is a schematic diagram of a processing procedure for adjusting a product model on the basis of life cycle data collected in a production process and a use process according to an embodiment of the present invention.

In FIG. 6, according to the direction indicated by the arrow of a life cycle timeline 40, the life cycle of a product successively goes through a product design process 10, a product production process 20 and a product use process 30.

An output result of the product design process 10 is a product model 21; a design parameter of the product and a unique identifier thereof, and a performance index of the product and a unique identifier thereof, are defined in the product model 21 by means of a data definer 23. The data definer 23 sends the unique identifier of the design parameter and a data source corresponding to the unique identifier to a first collecting side 25, and sends the unique identifier of the performance index and a data source corresponding to the unique identifier to a second collecting side 26. In the product production process 20, the first collecting side 25 acquires specific values of the processing precision of a hole that is produced, packages these specific values with the unique identifier, and sends same to the data collector 24 as collected data. In the product use process 30, the second collecting side 26 acquires an index value of the performance index from the data source, packages the index value with the unique identifier, and sends same to a data collector 24 as collected data. The data collector 24 can send the collected data provided by the first collecting side 25 and the second collecting side 26 to the data model 21 directly, so that the product model 21 adjusts the performance index included in the product model 21 on the basis of a result of comparing a statistical analysis result of the index value in the collected data provided by the second collecting side 26 with a predetermined threshold, and adjusts the design parameter included in the product model 21 on the basis of a result of comparing a statistical analysis result of the parameter value in the collected data provided by the first collecting side 25 with a predetermined threshold. The data collector 24 may also send the collected data provided by the first collecting side 25 and the second collecting side 26 to a simulation tool 22; the simulation tool 22 provides an output result to the product model 21 on the basis of the collected data provided by the first collecting side 25 and the second collecting side 26, then the product model 21 adjusts the performance index and the design parameter included in the product model 21 on the basis of the output result of the simulation tool 22.

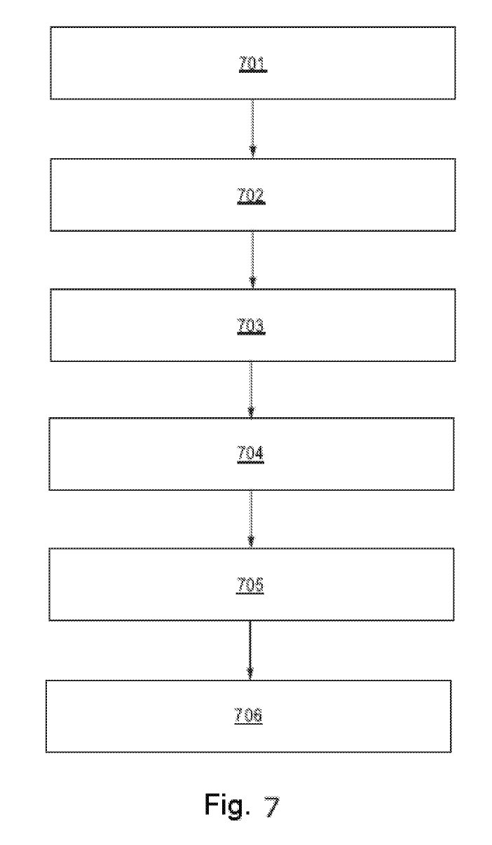

FIG. 7 is a demonstrative flow chart of the processing procedure shown in FIG. 6.

As FIG. 7 shows, the method comprises:

Step 701: the design parameter of the product and the unique identifier thereof, and the performance index of the product and the unique identifier thereof, are defined in the product model 21 by means of the data definer 23.

Step 702: the data definer 23 sends the unique identifier of the design parameter and the data source corresponding to the unique identifier to the first collecting side 25, and sends the unique identifier of the performance index and the data source corresponding to the unique identifier to the second collecting side 26.

Step 703: in the product production process 20, the first collecting side 25 acquires a specific value of the design parameter from the design parameter data source; in the product use process 30, the second collecting side 26 acquires a specific value of the performance index from the performance index data source.

Step 704: the first collecting side 25 packages the specific value of the design parameter with the unique identifier of the design parameter, and sends same to the data collector 24 as collected data; the second collecting side 26 packages the specific value of the performance index with the unique identifier of the performance index, and sends same to the data collector 24 as collected data.

Step 705: the data collector 24 may send the collected data provided by the first collecting side 25 and the second collecting side 26 to the data model 21 directly, or to the simulation tool 22.

Step 706: the product model 21 adjusts the design parameter included in the product model 21 on the basis of the result of comparing the statistical analysis result of the parameter value in the collected data with the predetermined threshold, and the product model 21 adjusts the index value included in the product model 21 on the basis of the result of comparing the statistical analysis result of the index value in the collected data with the predetermined threshold. Alternatively, the product model 21 adjusts the design parameter included in the product model 21, and adjusts the index value included in the product model 21, on the basis of the output result of the simulation tool 22.

Based on the description above, an embodiment of the present invention also proposes an apparatus for adjusting a product model.

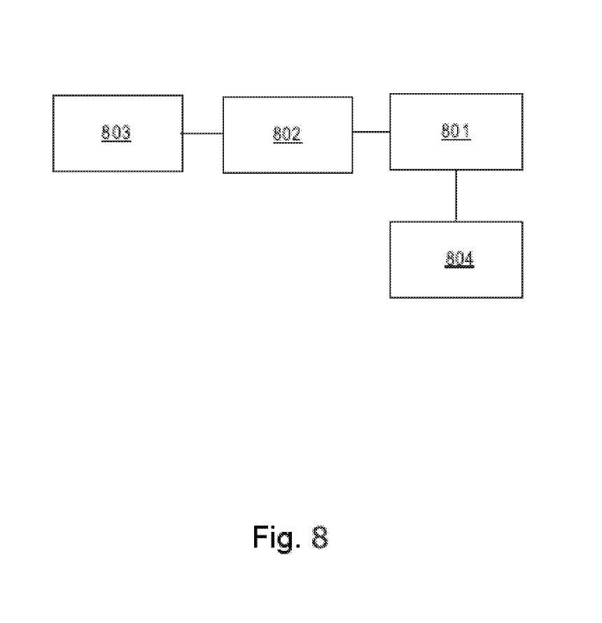

FIG. 8 is a structural diagram of an apparatus for adjusting a product model according to an embodiment of the present invention.

As FIG. 8 shows, an embodiment of the apparatus comprises:
a data type determining module 801, for determining a life cycle data type of a product corresponding to the product model;
a parameter value collecting module 802, for collecting, in a life cycle of the product, a parameter value which is associated with the product and complies with the life cycle data type;
a product model adjusting module 803, for adjusting the product model on the basis of the parameter value collected.

In one embodiment, the life cycle data type comprises one or more design parameters of the product;
the parameter value collecting module 802 is used for acquiring, in a production process of the product, a parameter value of the one or more design parameters from a product data management system or a manufacturing execution system.

In one embodiment, the life cycle data type comprises one or more performance indices of the product;
the parameter value collecting module 802 is used for acquiring, in a use process of the product, an index value of the one or more performance indices from a manufacturing execution system or an industrial Internet of Things.

In one embodiment, the life cycle data type comprises one or more design parameters of the product and one or more performance indices of the product;
the parameter value collecting module 802 is used for acquiring, in a production process of the product, a parameter value of the one or more design parameters from a product data management system or a manufacturing execution system, and for acquiring, in a use process of the product, an index value of the one or more performance indices from a manufacturing execution system or an industrial Internet of Things.

In one embodiment, also included is:
an identifier generating module 804, for generating a unique identifier of the life cycle data type;
wherein the parameter value collecting module 802 is used for sending the unique identifier of the life cycle data type and a data source of the life cycle data type to a collecting side, and receiving, from the collecting side, a parameter value which originates in the data source, is identified using the unique identifier, is associated with the product and complies with the life cycle data type.

In one embodiment, the collecting side comprises at least one of the following: a product data management system; a manufacturing execution system; an industrial Internet of Things, etc.

In one embodiment, the product model adjusting module 803 is used for inputting the parameter value collected into the product model, enabling the product model to adjust a performance index or design parameter included in the product model on the basis of a result of comparing a statistical analysis result of the parameter value with a predetermined threshold; or is used for inputting the parameter value collected into a simulation tool, and adjusting a performance index or design parameter included in the product model on the basis of an output result of the simulation tool.

Based on the detailed description above, an embodiment of the present invention also proposes an apparatus for adjusting a product model, comprising: at least one memory, for storing a machine-readable instruction; and at least one processor, for calling the machine-readable instruction to execute any one of the methods described above. The memory in the abovementioned information processing apparatus may be a high-speed random access memory, such as a dynamic random access memory (DRAM), static random access memory (SRAM), or another random storage solid-state storage device; or a non-volatile memory, such as one or more magnetic disk storage devices, optical disk storage devices, flash memory devices or other non-volatile storage devices.

It must be explained that not all of the steps and modules in the flows and structural diagrams above are necessary; certain steps or modules may be omitted according to actual requirements. The order in which steps are executed is not fixed, but may be adjusted as required. The partitioning of the modules is merely functional partitioning, employed for the purpose of facilitating description; during actual implementation, one module may be realized by multiple modules, and the functions of multiple modules may be realized by the same module; these modules may be located in the same device, or in different devices.

Hardware modules in the embodiments may be realized mechanically or electronically. For example, one hardware module may comprise a specially designed permanent circuit or logic device (such as a dedicated processor, such as an FPGA or ASIC) for completing a specific operation. The hardware module may also comprise a programmable logic device or circuit that is temporarily configured by software (e.g. comprising a general processor or another programmable processor) for executing a specific operation. The choice of whether to specifically use a mechanical method, or a dedicated permanent circuit, or a temporarily configured circuit (e.g. configured by software) to realize the hardware module can be decided according to considerations of cost and time.

Furthermore, each embodiment of the present application can be realized by way of a data processing program executed by a data processing device such as a computer. Clearly, the data processing program forms the present application. Furthermore, a data processing program stored in a storage medium is generally executed by reading the program directly from the storage medium or by installing or copying the program onto a storage device (e.g. hard disk and/or internal memory) of a data processing device. Therefore, such a storage medium also forms the present application. The present application also provides a non-volatile storage medium, in which is stored a data processing program capable of being used to execute any one of the abovementioned method examples in the embodiments of the present invention.

An embodiment of the present invention also provides a machine-readable storage medium, in which is stored an instruction for causing a machine to execute any of the methods described above. Specifically, a system or apparatus equipped with a storage medium may be provided; software program code realizing the function of any one of the embodiments above is stored on the storage medium, and a computer (or CPU or MPU) of the system or apparatus is caused to read and execute the program code stored in the storage medium. Furthermore, it is also possible to cause an operating system etc. operating on a computer to complete a portion of, or all, actual operations by means of an instruction based on program code. It is also possible for program code read out from the storage medium to be written into a memory installed in an expansion board inserted in the computer, or written into a memory installed in an expansion unit connected to the computer, and thereafter instructions based on the program code cause a CPU etc. installed on the expansion board or expansion unit to execute a portion of and all actual operations, so as to realize the function of any one of the embodiments above.

Embodiments of storage media used for providing program code include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROM. Optionally, program code may be downloaded from a server computer via a communication network.

The embodiments above are merely example embodiments of the present invention, which are not intended to define the scope of protection of the present invention. Any amendments, equivalent substitutions or improvements etc. made within the spirit and principles of the present invention shall be included in the scope of protection thereof.

The patent claims of the application are formulation proposals without prejudice for obtaining more extensive patent protection. The applicant reserves the right to claim even further combinations of features previously disclosed only in the description and/or drawings.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for adjusting a product model, comprising:
determining a life cycle data type of a product corresponding to the product model;
collecting, in a life cycle of the product, a parameter value associated with the product and complying with the life cycle data type determined; and
adjusting the product model based upon the parameter value collected.

2. The method for adjusting a product model of claim 1, wherein the life cycle data type comprises one or more design parameters of the product; and wherein the collecting includes:
acquiring, in a production process of the product, a parameter value of the one or more design parameters from a product data management system or a manufacturing execution system.

3. The method for adjusting a product model of claim 1, wherein the life cycle data type comprises one or more performance indices of the product; and wherein the collecting includes:
acquiring, in a use process of the product, an index value of the one or more performance indices from a manufacturing execution system or an industrial Internet of Things.

4. The method for adjusting a product model of claim 1, wherein the life cycle data type comprises one or more design parameters of the product and one or more performance indices of the product; and wherein the collecting includes:
acquiring, in a production process of the product, a parameter value of the one or more design parameters from a product data management system or a manufacturing execution system, and
acquiring, in a use process of the product, an index value of the one or more performance indices from a manufacturing execution system or an industrial Internet of Things.

5. The method for adjusting a product model of claim 1, further comprising:
generating a unique identifier of the life cycle data type, wherein the collecting includes:
sending the unique identifier of the life cycle data type and a data source of the life cycle data type to a collecting side;
receiving, from the collecting side, a parameter value which originates in the data source, is identified using the unique identifier, is associated with the product and complies with the life cycle data type.

6. The method for adjusting a product model of claim 5, wherein the collecting side comprises at least one of:
a product data management system;
a manufacturing execution system; and
an industrial Internet of Things.

7. The method for adjusting a product model of claim 1, wherein the adjusting includes:
inputting the parameter value collected into the product model, enabling the product model to adjust a performance index or design parameter included in the product model based upon a result of comparing a statistical analysis result of the parameter value with a threshold; or
inputting the parameter value collected into a simulation tool, and adjusting a performance index or design parameter included in the product model based upon an output result of the simulation tool.

8. An apparatus for adjusting a product model, comprising:
a data type determining module, to determine a life cycle data type of a product corresponding to the product model;
a parameter value collecting module, to collect, in a life cycle of the product, a parameter value associated with the product and complying with the life cycle data type determined; and
a product model adjusting module, to adjust the product model based upon the parameter value collected.

9. The apparatus for adjusting a product model of claim 8, wherein the life cycle data type includes one or more design parameters of the product; and wherein
the parameter value collecting module is used to acquire, in a production process of the product, a parameter value of the one or more design parameters from a product data management system or a manufacturing execution system.

10. The apparatus for adjusting a product model of claim 8, wherein the life cycle data type includes one or more performance indices of the product; and wherein
the parameter value collecting module is used to acquire, in a use process of the product, an index value of the one or more performance indices from a manufacturing execution system or an industrial Internet of Things.

11. The apparatus for adjusting a product model of claim 8, wherein the life cycle data type includes one or more design parameters of the product and one or more performance indices of the product; and wherein
the parameter value collecting module is used to acquire, in a production process of the product, a parameter value of the one or more design parameters from a product data management system or a manufacturing execution system, and to acquire, in a use process of the product, an index value of the one or more performance indices from a manufacturing execution system or an industrial Internet of Things.

12. The apparatus for adjusting a product model of claim 8, further comprising:
an identifier generating module, to generate a unique identifier of the life cycle data type, wherein the parameter value collecting module is used to send the unique identifier of the life cycle data type and a data source of the life cycle data type to a collecting side, and to receive, from the collecting side, and
wherein a parameter value originating in the data source is identified using the unique identifier, is associated with the product, and complies with the life cycle data type.

13. The apparatus for adjusting a product model of claim 12, wherein the collecting side comprises at least one of:
a product data management system;
a manufacturing execution system; and
an industrial Internet of Things.

14. The apparatus for adjusting a product model of claim 8, wherein the product model adjusting module is used
to input the parameter value collected into the product model, to enable the product model to adjust a performance index or design parameter included in the product model based upon a result of comparing a statistical analysis result of the parameter value with a threshold; or
to input the parameter value collected into a simulation tool, to adjust a performance index or design parameter included in the product model based upon an output result of the simulation tool.

15. A non-transitory storage medium storing a machine-readable instruction, the machine-readable instruction being usable for executing the method of claim 1 when executed on a computer.

16. A non-transitory storage medium storing a machine-readable instruction, the machine-readable instruction being usable for executing the method of claim 2 when executed on a computer.

17. A non-transitory storage medium storing a machine-readable instruction, the machine-readable instruction being usable for executing the method of claim 3 when executed on a computer.
